(19) United States
(12) Patent Application Publication
(10) Pub. No.: US 2012/0327312 A1
(43) Pub. Date: Dec. 27, 2012

(54) LIGHTING DEVICE, DISPLAY DEVICE AND TELEVISION RECEIVER

(75) Inventor: Takaharu Shimizu, Osaka-shi (JP)

(73) Assignee: SHARP KABUSHIKI KAISHA, Osaka-shi, Osaka (JP)

(21) Appl. No.: 13/582,507

(22) PCT Filed: Feb. 3, 2011
(86) PCT No.: PCT/JP2011/052214

§ 371 Date: Sep. 4, 2012

(30) Foreign Application Priority Data
Mar. 10, 2010 (JP) 2010-053347

(51) Int. Cl. F21V 7/00; H04N 5/66; F21V 29/00; G02F 1/13357; F21V 11/00; F21V 13/10

(52) U.S. Cl. 348/739; 362/311.01; 362/296.02; 362/235; 362/602; 349/64; 348/E05.133

(57) ABSTRACT

Technology of preventing or reducing uneven brightness on a light exit surface of a lighting device is provided. A backlight unit 24 includes an LED light source 28 having directivity and a diffuser plate 20 configured to diffuse light from the LED light source 28. A plate surface 20a of the diffuser plate 20 is exposed to the LED light source 28. The LED light source 28 is arranged such that light therefrom enters the plate surface 20a of the diffuser plate 20 at an entrance angle s of an acute angle.

### TECHNICAL FIELD

The present invention relates to a lighting device, a display device and a television receiver.

### BACKGROUND ART

In recent years, a type of a display element of an image display device including a television receiver has been shifted from a conventional CRT display device to a thin display device using a thin display element such as a liquid crystal panel and a plasma display and a thin image display device is made possible. A liquid crystal panel used for a liquid crystal display device does not emit light, and thus a backlight unit is required as a separate lighting device.

In the backlight unit, technology of using a light source emitting light having directivity such as an LED is known. For example, the backlight unit disclosed in the Patent Document 1 includes light sources emitting light having directivity and a diffuser plate configured to diffuse light from the light sources. Light from the light sources directly enters the diffuser plate without traveling through a light guide plate, for example. The diffuser plate is provided on a front-surface side of the backlight unit and, on a rear-surface side of the diffuser plate, a plurality of light sources emitting light having directivity are arranged close to the diffuser plate and are exposed thereto. Light from the light sources enters the diffuser plate such that light axis of the light is perpendicular to the rear surface of the diffuser plate. In the backlight unit, a light guide plate and the like are not included, and thus the thin backlight unit is achieved with low cost.

Patent Document 1: Japanese Unexamined Patent Publication No. 2008-198398

### Problem to be Solved by the Invention

To reduce power consumption and manufacturing cost of the backlight unit, the number of light sources in the backlight unit is necessary to be decreased. In the backlight unit of Patent Document 1, the light sources are provided close to the diffuser plate and emit light having directivity. The light having directivity directly enters the diffuser plate without traveling through a light guide plate and the like such that the light axis is perpendicular to the diffuser plate. Therefore, an area that the light enters is small in the diffuser plate. With such a configuration, reduction in the number of light sources increases the difference between brightness of a portion of the rear surface of the diffuser plate facing the light sources and brightness of a portion of the rear surface not facing the light sources. As a result, uneven brightness is caused on a light exit surface of the backlight unit.

### Disclosure of the Present Invention

The present invention was accomplished in view of the above circumstances. It is an object of the present invention to provide technology of preventing or reducing uneven brightness on a light exit surface of a lighting device in which light from a light source directly enters a diffuser plate without traveling through a light guide plate and the like.

### Means for Solving the Problem

The technology disclosed in the present invention includes a lighting device including a light source emitting light having directivity and a diffuser plate configured to diffuse the light from the light source and including a plate surface exposed to the light source. In the lighting device, the light source is arranged such that light therefrom enters the plate surface of the diffuser plate at an entrance angle of an acute angle.

Compared to the configuration in which light having directivity enters a light entrance surface at an entrance angle of zero degree (namely, a light axis of the light is perpendicular to the light emitting surface), the same amount of light having directivity enters a larger area of the light entrance surface at an entrance angle of an acute angle. In a conventional lighting device, light from a light source directly enters a diffuser plate without traveling through a light guide plate and the like and an entrance angle of the light with respect to a plate surface of the diffuser plate is zero degree. Compared to such a conventional configuration, in the present lighting device, light enters a larger area of the plate surface of the diffuser plate so as not to be concentrated on a part (on a small area) of the plate surface thereof. Such a configuration uniforms brightness distribution on the plate surface of the diffuser plate, and thus uneven brightness that is caused on the light exit surface of the lighting device is prevented or reduced. According to the present technology, an entrance angle of light means an angle formed between a light axis of the light and a normal line of the light entrance surface.

In the lighting device, the entrance angle may range from 10 to 88 degrees. With such a configuration, light from the light source enters a larger area of the plate surface of the diffuser plate. Therefore, uneven brightness is less likely to be caused in the light exit surface of the lighting device. Specifically, if the entrance angle is less than 10 degrees, the area that light enters may be small. If the entrance angle is more than 88 degrees, the area that light enters may be small and some rays of light may not enter the diffuser plate.

The lighting device may further include a reflection sheet including a reflection surface facing the diffuser plate. The light source may be provided between the plate surface of the diffuser plate and the reflection surface of the reflection sheet. With such a configuration, light that is emitted from the light source and reaches the reflection sheet reflects off the reflection surface of the reflection sheet and is directed toward the plate surface of the diffuser plate. This improves entrance efficiency of light that enters the diffuser plate from the LED light source.

In the lighting device including the reflection sheet, the reflection surface of the reflection sheet may be white. With such a configuration, reflection efficiency of the reflection sheet is improved.

The lighting device may further include a housing member housing the light source and the diffuser plate and including an elongated bottom surface and side surfaces. The light source may include a plurality of light sources and the light sources maybe arranged along the side surfaces extending in the elongated direction of the housing member. With such a configuration, light from each of the light sources enters a large area of the plate surface of the diffuser plate. Therefore, brightness of the lighting device is improved.

The lighting device may further include a supporting member attached to the housing member and supporting the light source, and having a heat dissipation property. With such a configuration, heat generated in the vicinity of the light sources is effectively dissipated outside of the lighting device through the supporting members.

In the lighting device, light from the light source may have directivity with a wide-angle. With such a configuration, light from the light source enters a larger area of the plate surface of the diffuser plate, and thus uneven brightness is less likely to be caused on the light exit surface of the lighting device.

The lighting device may further include a light source board on which the light source is arranged. The light source board may have a surface with a resist applied thereto and the resist reflecting light. With such a configuration, light that is emitted from the light source and travels in the vicinity of the front surface of the light source board is directed to the plate surface of the diffuser plate by the resist. Therefore, this improves entrance efficiency of light that enters the plate surface of the diffuser plate from the light source.

Next, to solve the above problem, a display device according to the present technology may include the above lighting device and a display panel configured to provide display using light from the lighting device. Furthermore, a display device configured to provide the display panel that is a liquid crystal panel using liquid crystal maybe new and useful. Furthermore, a television receiver including the display device may be new and useful. The large-screen display device and the large-screen television receiver are made possible.

### Advantageous Effect of the Invention

According to the present technology, uneven brightness is prevented or less likely to be caused on a light exit surface of a lighting device in which light from a light source directly enters a diffuser plate without traveling through a light guide plate and the like.

### BRIEF DESCRIPTION OF THE DRAWINGS

FIG. 1 is an exploded perspective view illustrating a television receiver 100;

FIG. 2 is an exploded perspective view illustrating a liquid crystal display device 10;

FIG. 3 is a sectional view illustrating the liquid crystal display device 10;

FIG. 4 is a perspective view illustrating supporting members 19 and an LED unit 32; and

FIG. 5 is a graph illustrating characteristics of directivity of light emitted from an LED light source 28.

### BEST MODE FOR CARRYING OUT THE INVENTION

### First Embodiment

An embodiment of the present invention will be described with reference to drawings. An X axis, a Y-axis and a Z-axis are described in apart of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

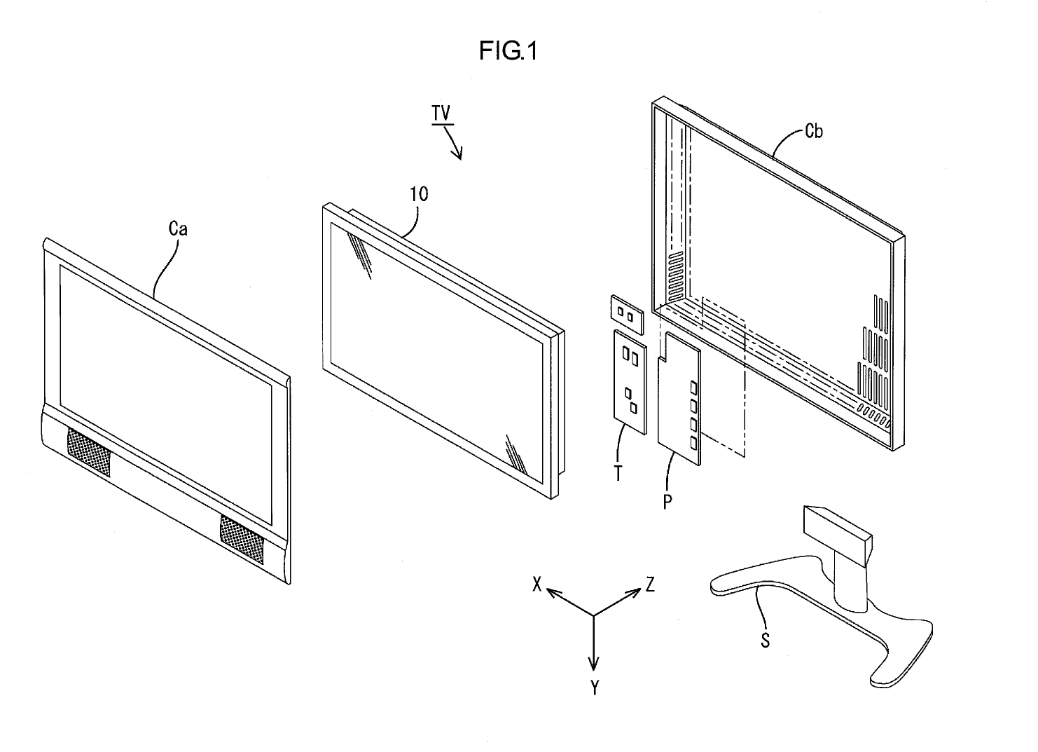

FIG. 1 illustrates an exploded perspective view of the television receiver TV according to an embodiment. As illustrated in FIG. 1, the television receiver TV includes the liquid crystal display device 10, front and rear cabinets Ca, Cb which house the liquid crystal display device 10 therebetween, a power source P, a tuner T and a stand S.

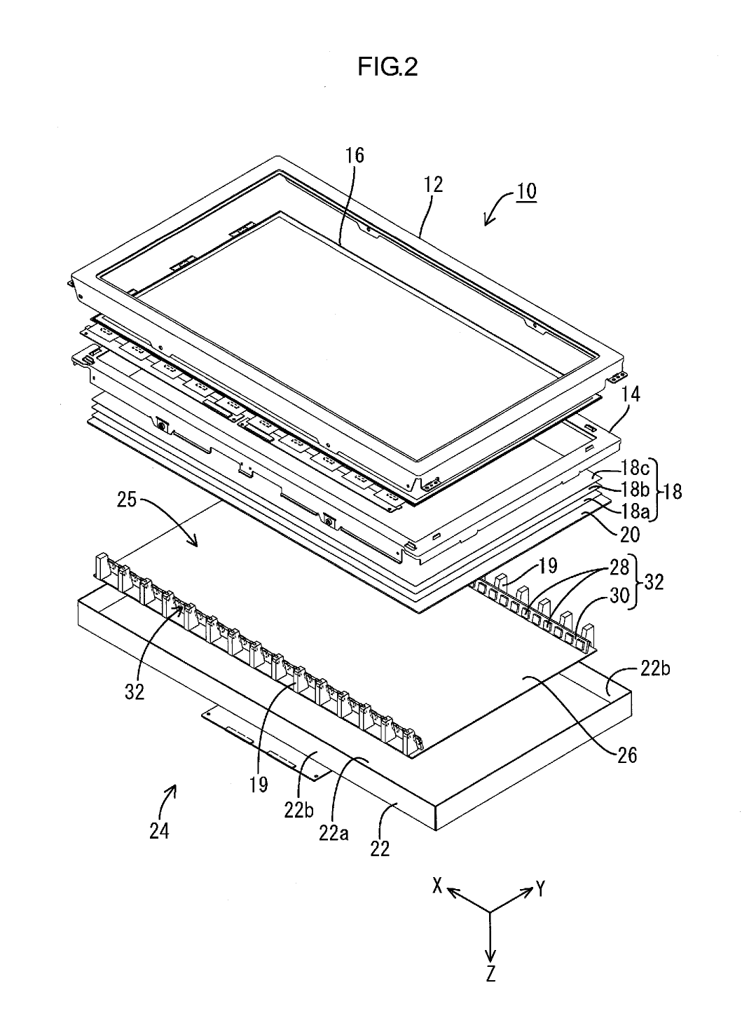

FIG. 2 illustrates an exploded perspective view of the liquid crystal display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (highly capable of light transmission) glass substrates is bonded together with a predetermined gap therebetween and a liquid crystal layer (not illustrated) is sealed between the glass substrates. On one of the glass substrates, switching components (e.g., TFTs) connected to source lines and gate lines that are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not illustrated) supplies image data and various control signals that are necessary to display images to the source lines, the gate lines and the counter electrodes. Polarizing plates (not illustrated) are attached to outer surfaces of the substrates.

Next, the backlight unit 24 will be explained. As illustrated in FIG. 2, the backlight unit 24 includes a backlight chassis 22, a diffuser plate 20, optical members 18, and a frame 14. The substantially box-shaped backlight chassis 22 has an opening on the front-surface side (on the light exit side and the liquid crystal panel 16 side). The diffuser plate 20 is provided on the front-surface side of the backlight chassis 22. The optical members 18 are provided on the front-surface side of the diffuser plate 20. The frame 14 is formed in a frame shape and supports the liquid crystal panel 16 along an inner periphery of the frame 14. Furthermore, a plurality of supporting members 19 and a pair of LED (light emitting diode) units 32 and 32 are arranged within the backlight chassis 22. The supporting members 19 are arranged in the long-side direction of the backlight chassis 22 and the supporting members 19 are arranged on respective long sides of outer edges of the backlight chassis 22. Each of the LED units 32 is arranged inside of the supporting members 19 and exits light.

The backlight chassis 22 is made of metal such as aluminum material. The backlight chassis 22 includes the rectangular bottom plate 22a in a plan view and the side plates 22b each of which rises shallowly from an outer edge of the corresponding side of the bottom plate 22a toward the front surface side. In the backlight chassis 22, a plate surface 20a of the diffuser plate 20 is exposed to the LED units 32 and space is formed therebetween. The space is light guide space 25 through which light from the LED units 32 and 32 travels. A reflection sheet 26 is provided on a front surface of the bottom plate 22a. A reflection surface 26a of the reflection sheet 26 faces the plate surface 20a of the diffuser plate 20. The light reflection sheet 26 reflects light that is exited from the LED units 32, 32 and not directed toward the plate surface 20a and directs the reflected light to the plate surface 20a of the diffuser plate 20. A power supply circuit board (not illustrated) is mounted on the rear-surface side of the bottom plate 22a and supplies power to the LED units 32.

The optical members 18 include laminated layers of a diffuser sheet 18a, a lens sheet 18b and a reflecting type polarizing sheet 18c in this order from the diffuser plate 20 side. The diffuser sheet 18a, the lens sheet 18c and the reflecting type polarizing sheet 18c are configured to produce planar light by using light that exits from the LED units 32 and travels the diffuser plate 20 therethrough. The liquid crystal panel 16 is provided on the front-surface side of the reflecting type polarizing sheet 18c. The optical members 18 are provided between the diffuser plate 20 and the liquid crystal panel 16.

The LED unit 32 includes an LED board 30 and the LED light sources 28. The rectangular LED board 30 is made from resin. The LED light sources 28 are arranged in a line on the LED board 30 and emit white light having directivity. The LED board 30 is adhered to inner surfaces of the supporting members 19, for example. The LED light source 28 may include a blue light emitting diode coated with a fluorescent material having an emission peak in a yellow range to emit white light. The LED light source 28 may include a blue light emitting diode coated with a fluorescent material having an emission peak in a green range and a red range to emit white light. The LED light source 28 may include a blue light emitting diode coated with a fluorescent material having an emission peak in a green range and a red light emitting diode to emit white light. The LED light source 28 may include a blue light emitting diode, a green light emitting diode and a red light emitting diode to emit white light. The LED light source 28 may include an ultraviolet light emitting diode and a fluorescent material. The LED light source 28 may include an ultraviolet light emitting diode coated with a fluorescent material having an emission peak in a blue range, a green range and a red range to emit white light.

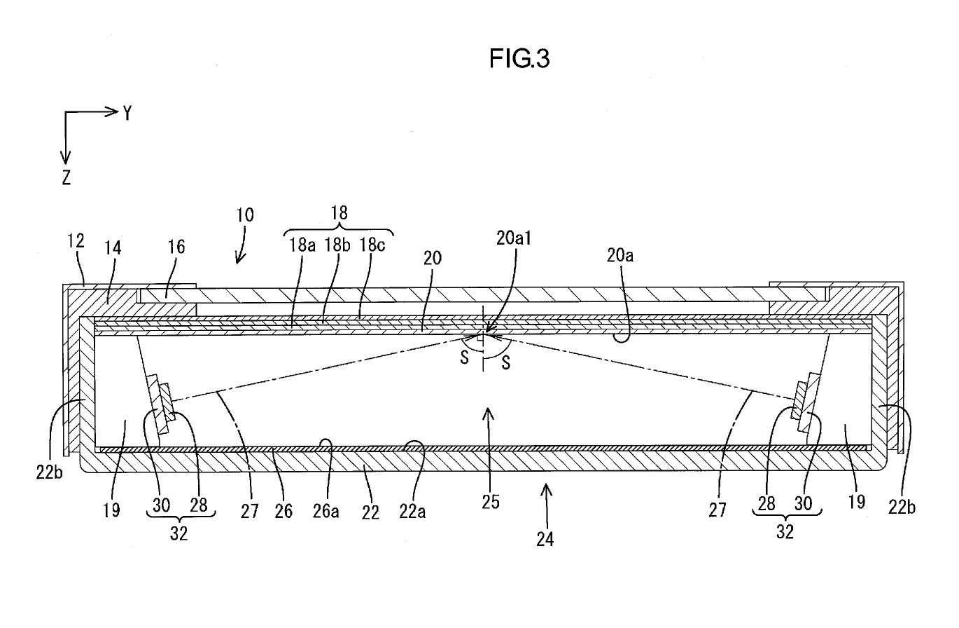

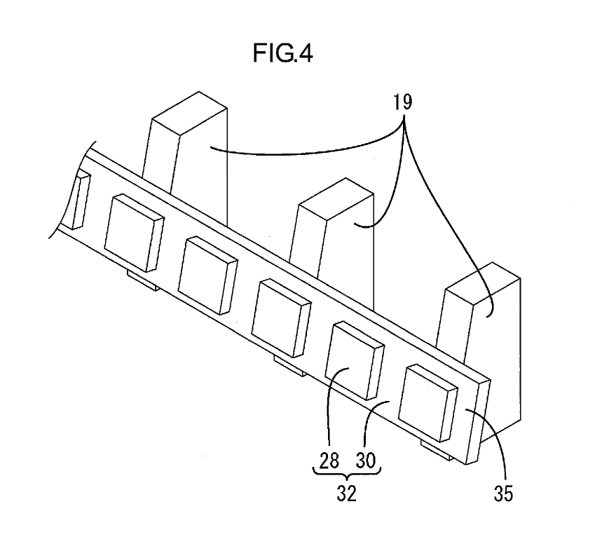

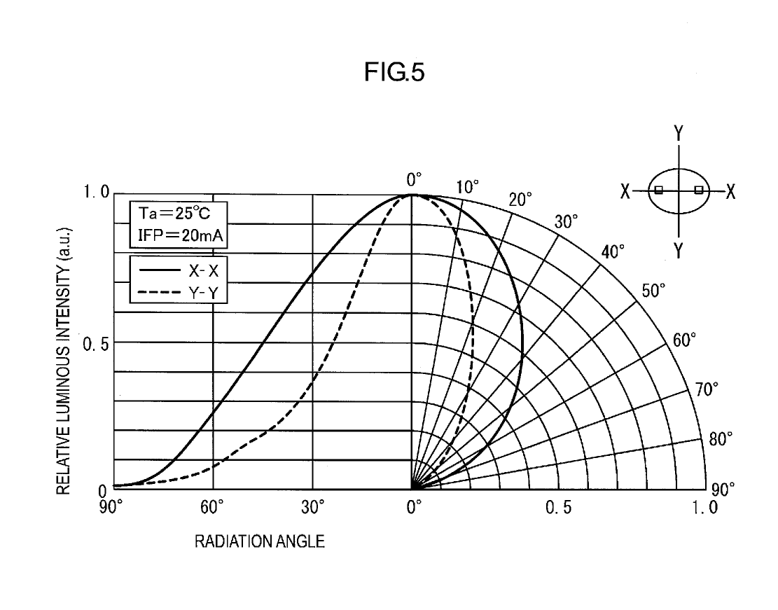

FIG. 3 illustrates a sectional view of the liquid crystal display device 10. FIG. 3 illustrates a sectional configuration of the liquid crystal display device 10 taken along the Y-Z plane so as to pass through the LED light sources 28. FIG. 4 illustrates a perspective view of the LED unit 32 and the supporting members 19. FIG. 5 illustrates characteristics of directivity of light emitted from the LED light source 28.

As illustrated in FIG. 4, the supporting members 19 are arranged at equal intervals in the long-side direction of the backlight chassis 22. The supporting members 19 are attached to the side plates 22b of the backlight chassis 22 with screws. The supporting members 19 are made of metal and heat dissipative. The LED board 30 is supported by the supporting members 19. A white resist 35 is applied to a front surface of the LED board 30.

As illustrated in FIG. 3, the LED unit 32 is fixed to surfaces of the supporting members 19 such that the light exit surface of the LED unit 32 faces the diffuser plate 20 in a slanted manner. Light is emitted from the LED light source 28 and the light enters the plate surface 20a of the diffuser plate 20 at an entrance angle s of an acute angle. Namely, a light axis 27 of light that is emitted from the LED light source 28 forms an acute angle with a normal line to the plate surface 20a of the diffuser plate 20. Specifically, the entrance angle s ranges from 10 to 88 degrees. Accordingly, light having directivity enters the plate surface 20a of the diffuser plate 20 at the entrance angle of an acute angle. This increases an area of the plate surface 20a of the diffuser plate 20 that the light enters compared to a configuration in which the same amount of light enters a diffuser plate at an entrance angle of zero degree.

Furthermore, the LED light source 28 emits light having directivity with a wide angle as illustrated in FIG. 5. Therefore, as illustrated in FIG. 3, the light having directivity reach middle part 20a1 of the plate surface 20a of the diffuser plate 20. Therefore, an entire surface of the liquid crystal panel 16 is illuminated with uniform bright light.

The television receiver TV according to the present embodiment has been explained in detail. In the backlight unit 24 of the television receiver TV according to the present embodiment, light from the LED light source 28 enters the plate surface 20a of the diffuser plate 20 at the entrance angle of an acute angle. In a conventional backlight unit, light directly enters a plate surface of a diffuser plate without traveling through a light guide plate and the like and enters the diffuser plate at an entrance angle of zero degree. Compared to the conventional configuration, light enters a larger area of the plate surface 20a of the diffuser plate 20 so as not to be gathered in apart of the plate surface 20a thereof in the present embodiment. This uniforms brightness distribution on the plate surface 20a of the diffuser plate 20, and thus uneven brightness in the liquid crystal panel 16 of the backlight unit 24 is prevented or less likely to be caused.

In the backlight unit 24 according to the present embodiment, the entrance angle s of light from the LED light source 28 with respect to the diffuser plate 20 ranges from 10 to 88 degrees. With such a configuration, light from the LED light source 28 enters a larger area of the plate surface 20a of the diffuser plate 20. Therefore, uneven brightness is less likely to be caused in the liquid crystal panel 16 of the backlight unit 24.

In the backlight unit 24 according to the present embodiment, the reflection surface 26a of the reflection sheet 26 faces the plate surface 20a of the diffuser plate 20. The LED light sources 28 are provided therebetween. With such a configuration, light that is emitted from the LED light sources 28 and reaches the reflection sheet 26 side reflects off the reflection surface 26a of the reflection sheet 26 to enter the plate surface 20a of the diffuser plate 20. This improves entrance efficiency of light that enters the diffuser plate 20 from the LED light source 28. Additionally, the reflection sheet 26 is white, and thus high reflection efficiency is obtained.

In the backlight unit 24 according to the present embodiment, the LED units 32 and the diffuser plate 20 are housed in the backlight chassis 22 that includes the elongated bottom plate 22a. A plurality of LED light sources 28 are arranged along the side plates 22b that extend respective long sides of the backlight chassis 22. With such a configuration, light from each of the LED light sources 28 enters a large area of the plate surface 20a of the diffuser plate 20. Therefore, the brightness of the backlight unit 24 is improved.

In the backlight unit 24 according to the present embodiment, the supporting members 19 support the LED light sources 28 and are attached to the backlight chassis 22, and the supporting members 19 are heat dissipative. Heat is generated in the LED board 30 due to light emission from the LED light sources 28, and the heat is effectively dissipated outside of the backlight unit 24 through the supporting members 19.

In the backlight unit 14 according to the present embodiment, the LED light source 28 emits light having directivity with a wide angle. Therefore, light from the LED light source 28 enters a larger area of the plate surface 20a of the diffuser plate 20, and thus uneven brightness is less likely to be caused in the liquid crystal panel 16 of the backlight unit 24.

In the backlight unit 24 according to the present embodiment, the LED light sources 28 are arranged on a front surface of the LED board 30 and the resist 35 that reflects light is applied thereon. With such a configuration, light that is emitted from the LED light source 28 and travels in the vicinity of the front surface of the LED board 30 is directed to the plate surface 20a of the diffuser plate 20 by the resist 35. Therefore, this improves entrance efficiency of light that enters the plate surface 20a of the diffuser plate 20 from the LED light source 28.

Correspondence relationships between the construction of the embodiment and the construction of the present technology will be described. The LED light source 28 is an example of a “light source.” The backlight unit 24 is an example of a “lighting device.” The backlight chassis 22 is an example of a “housing member.” The LED board 30 is an example of a “light source board.”

Modification examples of the above embodiment will be explained.

(1) In the embodiment, the LED units are fixed to the supporting members so as to face the diffuser plate in a slanted manner. However, for example, a lens member may be provided to cover alight exit surface of the LED light source. Light is emitted from the LED light source and the lens member may direct the light to the diffuser plate.

(2) In the embodiment, the LED units are arranged along the respective long sides of outer edges of the backlight chassis. The LED units may be provided in any other positions in the backlight chassis.

(3) In addition to the above embodiment, the arrangement and configuration of the LED units and the supporting members may be altered if necessary.

(4) In the above embodiment, the liquid crystal display device including the liquid crystal panel as a display panel. The technology can be applied to display devices including other types of display components.

(5) In the above embodiment, the television receiver including the tuner is used. However, the technology can be applied to a display device without a tuner.

The embodiment according to the present technology has been described in detail. The embodiment is for illustrative purposes only and by no means limits the scope of the present technology. Technologies described in the present invention include variations and modifications of the embodiment and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings realize a plurality of purposes at the same time and have a technical usefulness when one of the purposes is realized.

### EXPLANATION OF SYMBOLS

TV: television receiver, Ca, Cb: cabinet, T: tuner, S: stand, 10: liquid crystal display device, 12: bezel, 14: frame, 16: liquid crystal panel, 18: optical members, 18a: diffuser sheet, 18b: lens sheet, 18c: reflecting type polarizing sheet, 19: supporting member, 20: diffuser plate, 20a: plate surface of the diffuser plate, 22: backlight chassis, 22a: bottomplate, 22b: side plate (edge portion of a long side), 24: backlight unit, 25: light guide space, 26: reflection sheet, 27: light axis, 28: LED light source, 30: LED board, 32: LED unit, 35: resist, s: entrance angle

1. A lighting device comprising:
a light source emitting light having directivity; and
a diffuser plate configured to diffuse the light from the light source and including a plate surface exposed to the light source,
wherein the light source is arranged such that light therefrom enters the plate surface of the diffuser plate at an entrance angle of an acute angle.

2. The lighting device according to claim 1, wherein the entrance angle ranges from 10 to 88 degrees.

3. The lighting device according to claim 1, further comprising a reflection sheet including a reflection surface facing the diffuser plate,
wherein the light source is provided between the plate surface of the diffuser plate and the reflection surface of the reflection sheet.

4. The lighting device according to claim 3, wherein the reflection surface of the reflection sheet is white.

5. The lighting device according to claim 1, further comprising a housing member including an elongated bottom surface and side surfaces and housing the light source and the diffuser plate, wherein:
the light source includes a plurality of light sources; and
the light sources are arranged along the side surfaces extending in an elongated direction of the housing member.

6. The lighting device according to claim 5, further comprising a supporting member attached to the housing member and supporting the light source, and having a heat dissipation property.

7. The lighting device according to claim 1, wherein light from the light source has directivity with a wide angle.

8. The lighting device according to claim 1, further comprising a light source board on which the light source is arranged, the light source board having a surface with a resist applied thereto, the resist reflecting light.

9. A display device comprising:
the lighting device according to claim 1; and
a display panel configured to provide display using light from the lighting device.

10. The display device according to claim 9, wherein the display panel is a liquid crystal panel using liquid crystals.

11. A television receiver comprising the display device according to claim 9.
